(19) United States
(12) Patent Application Publication
(10) Pub. No.: US 2015/0302757 A1
(43) Pub. Date: Oct. 22, 2015

(54) LEARNING AID

(71) Applicant: Sanjay Bansal, Wolverhampton, West Midlands (GB)

(72) Inventor: Sanjay Bansal, Wolverhampton, West Midlands (GB)

(21) Appl. No.: 14/437,679

(22) PCT Filed: Oct. 28, 2013
(86) PCT No.: PCT/GB2013/052812

§ 371 Date: Apr. 22, 2015

(30) Foreign Application Priority Data
Oct. 26, 2012 (GB) 1219360.3

(51) Int. Cl. G09B 11/04; G09B 5/02

(52) U.S. Cl. CPC G09B 11/04; G09B 5/02

(57) ABSTRACT

A learning aid (10) includes a display member (12) for displaying a predefined symbol set (14), a sensor (16) for detecting interaction by a user in use, and a guide member (18). In a use condition, the guide member (18) overlays the display member (12) to guide the interaction by the user.

### FIELD OF THE INVENTION

The present invention relates to a learning aid, more particularly but not exclusively a learning aid to assist with writing.

### BACKGROUND

Children's education is very important and many parents are keen to enhance their child's learning by using learning aids to further education in the home environment.

A major part of early learning for children is how they write and children may spend many hours practicing the skills required for this. Outside of the school environment it may be harder to encourage children to practice their writing skills due to other distractions such as toys or television.

Therefore parents will often need to dedicate time to this in the home and come up with ways to make it fun and exciting. In order to enhance the learning experience learning aids may be used such as writing/colouring books or electronic aids.

Electronic aids may be re-used making them a desirable option, however often a parent will be required to assist the child with the tasks to ensure successful learning for example to set up and monitor use of a computer. Also a number of learning aids for writing encourage a child to write but may not also provide guidance as to how to for example form the letters on paper.

The present invention arose to overcome the problems associated with requirement for parental input with electronic learning aids by providing a learning aid that gives tasks and guidance so that the child may work independently.

### PRIOR ART

Accordingly a number of patent applications have been filed in an attempt to resolve the problem or similar, including the following:

United States patent application US2011065081 (WEN) discloses an electrically erasable writable educational flash card, comprising: an electronic display panel for displaying prescribed patterns such as text characters of a language. Arabic numbers, and graphics pictures of a learning subject; a display driver, operably connected to said electronic display panel for erasing and writing said prescribed patterns on said electronic display panel; an interface operably connected to said display driver and to an external information transmission source; and a housing of certain mass, size and stiffness made of a material selected from a group comprising conventional paper, plastic, aluminium, stainless steel, or the like and combination thereof, whereon said electronic display panel, said display driver and said interface are arranged and housed.

GrantedAustralian patent AU2005251170 (MCILVAIN et al) discloses an interactive electronic device comprising: a sequence of language symbols; a language-symbol selector having a sight, the sequence of language symbols and the language-symbol selector movable in relation to one another such that each language symbols of the sequence of language symbols is viewable in the sight; a graphic user interface; and control electronics comprising an electronic memory having stored therein a plurality of traceable templates, each traceable template representing one language symbol of the sequence of language-symbol, the control electronics operatively coupled to the language-symbol selector and to the graphic user interface, wherein selection of the one language symbol of the sequence of language-symbol when the one language symbol is viewable in the sight causes the graphic user interface to produce the traceable template corresponding to the one language symbol and to produce a visible rendering of a movement of an affector as the affector traces the traceable template.

Granted U.S. Pat. No. 6,802,717 (CASTRO) discloses a method of teaching the alphabet comprising the steps of: providing an electronic teaching device having a keyboard with keys for the letters of the alphabet, a touch screen area for displaying each letter in response to actuation of the key for that letter, a speaker for delivering selected recorded audio messages with the display of a selected letters, and a second screen area for displaying a selected picture of an object with the delivery of a selected audio message; causing a letter to be displayed on said touch screen area in response to the actuation of the key for that letter, and concurrently causing an introductory audio message to be delivered that identifies the selected letter; causing the selected letter to disappear from the touch screen and causing a series of outline elements to appear sequentially representing the sequence of strokes to be used for writing the letter, and concurrently causing intermediate audio messages to be delivered that instruct the user to follow the series of outline elements; delivering a concluding audio message through the speaker identifying the selected letter, instructing in its phonetic pronunciation and providing an exemplary word identifying an object constituting an example of the use of the letter; and simultaneously displaying on said second screen area a picture of the object that is identified by the word provided in the concluding audio message.

In contrast the present invention provides a pie means of combining electronic advancements with traditional writing skills.

### SUMMARY OF THE INVENTION

According to a first aspect of the present invention, there is provided a learning aid including a display member for displaying a predefined symbol set, a sensor for detecting interaction by a user in use, and a guide member which in a use condition overlays the display member to guide the interaction by the user.

Possibly, the guide member defines at least one aperture. Possibly, the aperture or apertures correspond to the symbolset.

Possibly, in the use condition, the sensor is located between the display member and the guide member.

Possibly, the display member, the sensor and the guide member comprise an interface.

Possibly, the display member, the sensor and the guide member are substantially planar. Possibly, the interface is substantially planar.

Possibly, the learning aid includes a casing and a lid. Possibly, the lid comprises the display member, the sensor and the guide member. Possibly, the lid comprises a cover member.

Possibly, the learning aid includes a mounting for mounting the lid to the casing. The mounting may permit detachment of the lid from the casing. The mounting may permit rotation of the lid around the casing, and may permit rotation of the lid through an angle of at least 340° around the casing.

Possibly, the lid is movable between a storage condition in which the cover member is outermost on one side of the casing and the use condition in which the guide member is outermost on the other side of the casing.

Possibly, the casing defines lid recesses, in which the lid is receivable in the storage and the use conditions.

Possibly, the learning aid includes a detectable tool, which is detectable by the sensor when within a detection range of or in contact with the sensor. The tool may be a pen or stylus, and may include a tip, which in use is locatable within the aperture(s).

The aid may include one or more alternative lids, each of which may include a different symbol set.

The or each aperture may be in the form of a groove. The aid may include an adjuster for adjusting the spacing between the guide member and the sensor.

Possibly, the display member includes a plurality of light emitters. Possibly, in use, at least some of the light emitters are illuminated to display at least part of the symbol set.

Possibly, the display comprises a printed circuit board.

Possibly, the sensor comprises a pad capable of registering interaction.

Possibly, the guide member comprises a perforated plate, which may be adapted to be arranged in use over the pad to alter parameters of interaction registered on the pad.

Possibly, the learning aid includes activation controls.

Possibly, the mounting is in the form of a double hinge. In this way the pad, lid and/or perforated plate(s) may be rotated through at least 340 degrees so as to move the interface from a first closedstorage position to a second openin use position.

Said pen may interact with the pad through provision of a touchscreen pad wherein the pen may be integral or independently provided, or said pen may interact with the pad through other means including magnetic input.

In all embodiments the learning aid serves to assist users and in particular children with learning to and improving their writing and drawing skills and/or to enhance dexterity.

Users write and draw on the pad, optionally with use of a plate as a guide, so as to facilitate learning. Advantageously the learning aid is envisaged to provide visual and auditory commands and feedback.

Preferably the casing is wedge-shaped so that the interface is angled in use to provide preferred working surface and preferred viewing angles. In order to allow the interface to travel from the first position to the second position in which it may be used the double hinge may be engaged so as to allow rotation of the interface around the wedged shaped casing.

In preferred embodiments the casing is formed from a strong, durable, lightweight material such as polypropylene.

The double hinge may include a first hinge and a second hinge. Ideally the interface or parts of the interface are displaceable from the casing by use of the first hinge, typically being displaced by more than 90 degrees. The first hinge is limited to a predetermined point wherein the second hinge becomes engaged to allow rotation of the interface to the casing's distal or opposing face, thereby exposing the interface for use.

The double hinge enables the interface to rotate around the wedge's thicker end and be positioned flush to the casing on either face of the casing. The casing is turned over during this process, no as to allow the interface to be used whilst on a surface such as a table.

Preferably the hinges are mounted concentrically within one another so as to reduce space taken up. Ideally two double hinges are provided, one at each end of the interface as it joins the casing, so as to limit flex of the interface during rotation.

Preferably the learning aid includes a roller shutter that may be displaced so as to reveal and hide a charging point. Ideally the shutter is included between the two hinges so as not to interfere with the interface or controls.

Ideally the casing also houses the activation controls including a plurality of buttons to control the learning aid, for example to activate and alter settings, such as sound or activities. In some embodiments the same button may be used to turn on and off the device and toggle through different settings, so as to minimise hard interface options and limit flexibility to software based applications, concurrently limiting hardware expense. Typically button use in such formats is distinguished by pressing the button for different lengths of time.

In preferred embodiments the interface comprises multiple layers including the lid, pad, and theplate or plates, wherein in use the interface is rotated through 340 degrees to reveal the second face, so that the layers are reversed with the plate uppermost.

Typically the plate includes perforated or cut out portions to represent letters, numbers or shapes so as to provide the user with an aid to recreating these. Ideally the plate is a thin, durable material such as synthetic plastic or rubber.

Advantageously thickness of the plate may be varied so as to adjust indentation provided for the user to trace. For example a thicker plate would allow the pen to trace shapes within distinct predefined channel whereas a thinner plate would provide only a shallow channel therefore requiring greater dexterity of the user.

It is envisaged that the plates may be interchangeable so as to vary skill level required and the out outs included on the aid for example from capital letters to non capital letters.

Ideally pressure is applied to the interface by means of a pen in regions predefined by the plate so as to generate a response to the user. Preferably the casing includes a recess to hold the pen so as to stow it with the learning aid or casing, when not in use.

In preferred embodiments the pen includes a magnet so as to create an electromagnetic field when in close proximity to a magnetised strip thereby engaging a printed circuit board (PCB) so as to generate a response.

Typically the PCB generates visual responses such as illumination of a plurality of lights in response to use of the pen. Ideally the lights are light emitting diodes (LEDs) mounted within or about the interface,whichare lit when triggered by the PCB. Preferably the regions touched by the pen become lit wherein the colour of the light may indicate when the region touched is right or wrong for the current task.

Ideally the plate guides the user as to where to place the pen. Preferably when the pen is connected with the interface in the correct location areas touched become lit to provide feedback to the user.

In preferred embodiments the PCB may include a setting to provide guide lighting to indicate to the user where to place the pen in order to complete tasks, for example tracing an alphabet letter. It is envisaged that the guide setting may be optional so as to be tailored to the user's skill level.

Ideally the guide setting may provide lighting of one colour to indicate the direction in which the pen must travel to write the letter. For example red lights may flash sequentially to reveal where the pen must travel to correctly draw the letter. Once the user has drawn the pen along the highlightedsequence the letter may remain lit but in a different colour such as green so as to advise the user that they have been successful. Ideally the lights change from red to green as the user traces the letter.

Additionally the learning aid may be programmed to include audible capability, for example to play back questions which may be answered by the user. whereinthe learning aid may include a speaker housed within the casing so as to receive and transmit sound andmay includea microphone.

Preferably the questions may require yes or no answers which the user may respond to by pushing respective buttons that may be included on the interface. Alternatively the user may be able to write their answer by using the pen to write the answer on theplate. Additionally the user may also be able to give a verbal response that is received by the microphone.

In preferred embodiments the learning aid may give an audible instruction or task to for the user to complete. For example instructions may be given to write the letter ‘a’ or write a word. When said task is completed successfully the traced shapes or letters are fully lit on the interface. It is envisaged that the aid may also provide an audible response when the task is completed.

Preferably the learning aid may also audibly acknowledge successful completion of a task by a particular sound of voiced congratulations. The learning aid may also advise when the task is not being completed correctly.

Advantageously, the learning aid includes a plurality of character buttons, typically on the casing side that control the audible voice emitted, for example a male or female voice, or a particular character so as to encourage the child to use the aid. Ideally each button may include a visual representation of the character on the button.

It is envisaged that the learning aid may accept interchangeable programsor be equipped with data transfer facilities so as to be able to change the form or level of learning. For example programs for alphabet learning, spelling, different questions or characters may be uploaded to provide variety for the users without requirement for purchase of multiple devices. In order to facilitate this wireless connectivity or hardware inputs may be included.

In preferred embodiments the pen includes a means of receiving and transmitting a signal so as to identify the pen location if lost. Preferably the learning aid includes a wireless button which may be pressed if the pen is lost. A wireless signal is sent out within a predefined radius. If the pen receives the signal an alert on the pen may be triggered for example a light may be turned on or an audible alarm may sound.

In some embodiments the interface may comprise a liquid crystal display (LCD) screen that may operate as a touch screen.

According to a second aspect of the present invention, there is provided a method of learning, the method including providing a learning aid, the aid including a display member for displaying a predefined symbol set, a sensor for detecting interaction by a user in use, and a guide member which in a use condition overlays the display member to guide the interaction by the user.

The aid may include any of the features described above or hereinafter. The method may include any of the steps described above or hereinafter.

### BRIEF DESCRIPTION OF FIGURES

Embodiments of the present invention will now be described, by way of example only, and with reference to the accompanying drawings, in which:

FIGS. 1A and 1B are perspective views from the front, one side and above of a learning aid in a use condition and a storage condition respectively;

FIG. 2 is a perspective view from the front, one side and below of learning aid in the storage condition;

FIGS. 3A is a view from below of the aid in the use condition as shown otherwise in FIG. 1A; FIG. 3B is a view from above of the aid in the storage condition as shown in FIG. 1B;

FIG. 4A is a side view of one side of the learning aid in the storage condition; FIG. 4B is a side view of the other side of the learning aid in the storage condition; and FIG. 4C is side view of the one side in the use condition;

FIG. 5 is an exploded perspective view of another learning aid;

FIG. 6 is a cross sectional side view through part of the learning aid of FIG. 5;

FIG. 7 is a perspective view of part of the learning aid of FIGS. 5 and 6;

FIG. 8 is a plan view of part of the learning aid of FIG. 5 in an open condition; and

FIG. 9 is a perspective view of a part of the learning aid of FIGS. 1 to 4 in use.

### DETAILED DESCRIPTION OF FIGURES

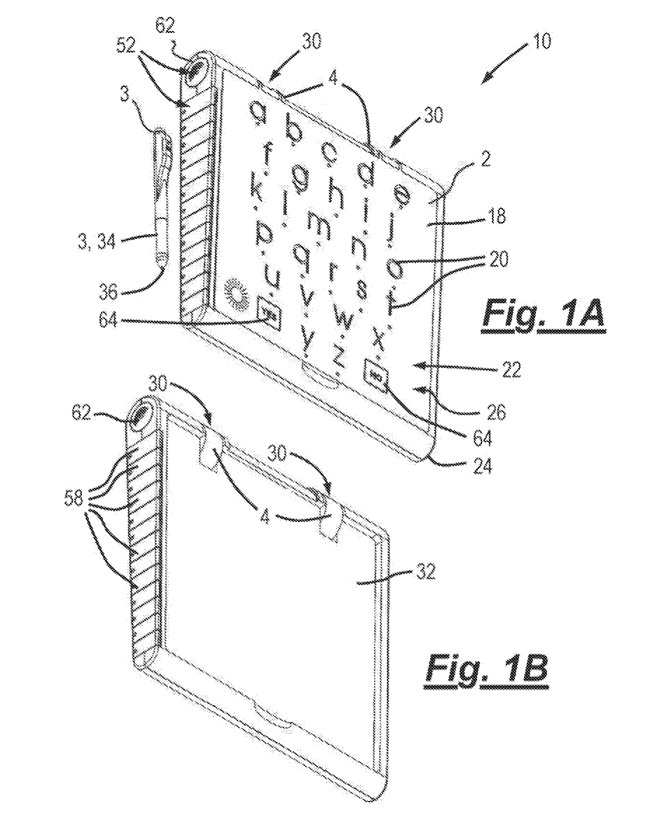

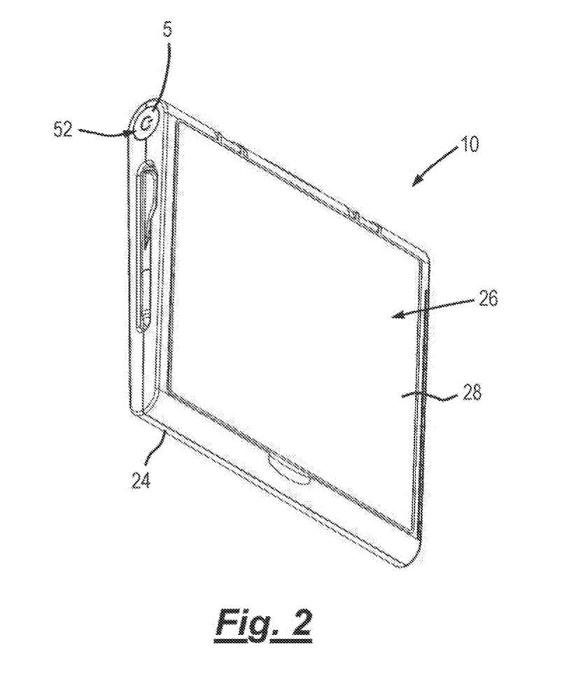

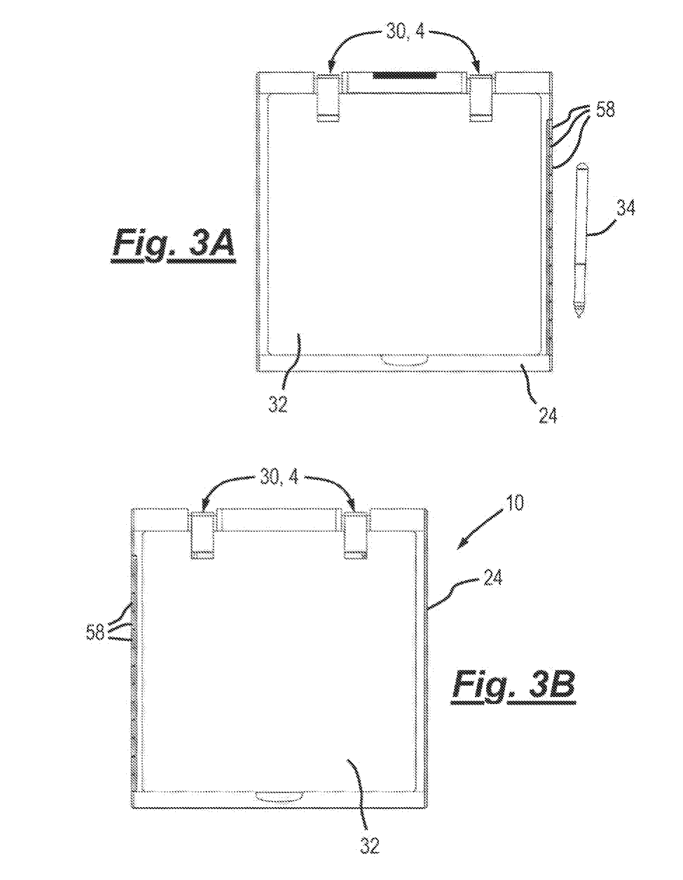

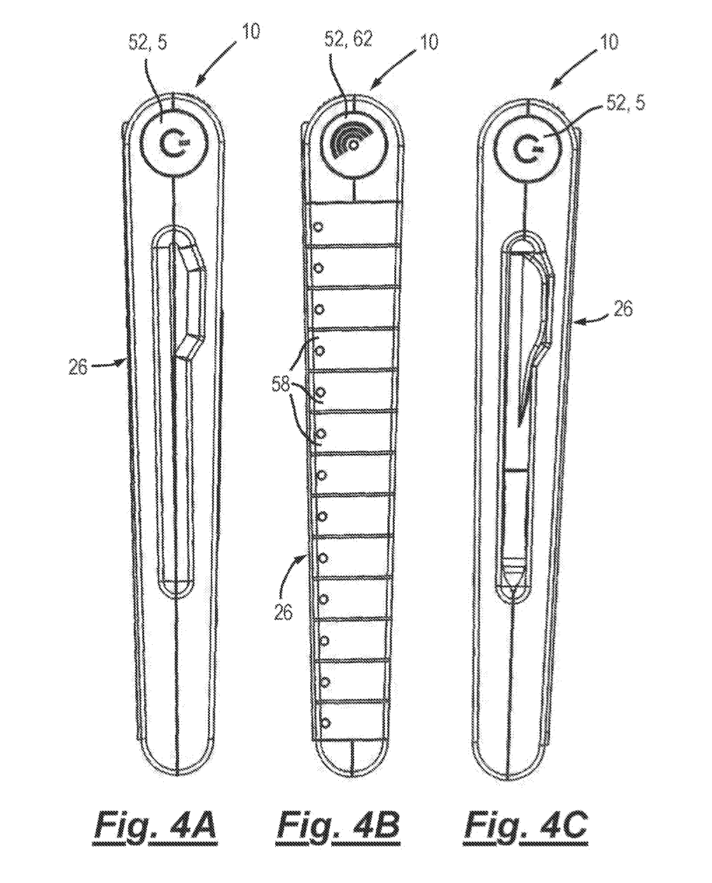

Referring to the Figures, FIGS. 1 to 4 show a learning aid 10 including a display member 12 for displaying a predefined symbol set 14, a sensor 16 for detecting interaction by a user in use, and a guide member 18 which in a use condition overlays the display member 12 to guide the interaction by the user.

The symbol set 14 could, for example, be the letters of the alphabet in lower case.

The guide member 18 defines apertures 20 which correspond in shape and location to the symbol set 14.

In the use condition, the sensor 16 is located between the display member 12 and the guide member 18.

The display member 12, the sensor 16 and the guide member 18 comprise an interface 22.

The display member 12, the sensor 16 and the guide member are substantially planar. The interface 22 is substantially planar.

The learning aid 10 includes a casing 24 and a lid 26. The lid 26 comprises the display member 12, the sensor 16, the guide member 18 and a cover member 28.

The learning aid 10 includes a mounting 30 for mounting the lid 26 to the casing 24. The mounting 30 permits rotation of the lid 26 around the casing 24. In one example, the mounting 30 permits rotation of the lid through an angle of at least 340° around the casing 24.

The mounting 30 includes a pair of spaced hinges 4, which are double hinges.

The lid 26 is movable between a storage condition in which the cover member 28 is outermost on one side of the casing 24 and the use condition in which the guide member 18 is outermost on the other side of the casing 24.

The casing 24 defines lid recesses 32, in which the lid 26 is receivable in the storage and the use conditions.

The learning aid includes a detectable tool 34, which is detectable by the sensor 16 when within a predetermined detection range of or in contact with the sensor 16. The tool 34 could be a pen 3 or stylus. The tool 34 includes a tip 36, which in use is locatable within the apertures 20.

The aid 10 could include one or more alternative lids, each of which could include a different symbol set.

Each aperture 20 could be in the form of a groove, and could be a through aperture, or could be a blind aperture.

The display member 12 includes a plurality of light emitters 50 in the form of LEDs. In use, at least some of the light emitters 50 are illuminated to display at least part of the symbol set 14. The sensor 16, which overlays the display member 12, permits light transmission therethrough, and could be in the form of a relatively thin membrane.

The display member 12 comprises a printed circuit board (PCB) 48.

The sensor 16 comprises a pad 1 capable of registering interaction.

The guide member 18 comprises a perforated plate 2, which is adapted to be arranged in use over the pad 1 to after parameters of interaction registered on the pad 1.

The learning aid 10 includes activation controls 52, which could include character buttons 50 to select different character related sounds; push buttons 64 to permit predefined specific user response eg yes or no; an activation button 5; and a wireless transmitter button 62.

The interaction pad 1 is covered with the perforated plate 2, wherein the pen 3 may be used to interact with the pad 1 through the plate 2 and the plate 2 is rotatable about and fixed to hinges 4.

The activation controls 52 include an activation button 5 to activate or deactivate the aid 10. The button 5 could be used for other user input. For example, pressing and holding the button 5 for more than two seconds could turn on the learning aid. Further pressing of the button 5 for less than two seconds could toggle the learning aid through different settings. The button 5 is included on the sides of the casing 24 so as not to interfere with interaction.

The aid 10 includes a power supply comprising one or more batteries (not shown) which could be located in the casing 24 and/or the lid 26, and a controller (not shown) which again could be located in the casing 24 and/or the lid 26. Wiring and/or other circuitry components are provided between the various components to communicate power and signals.

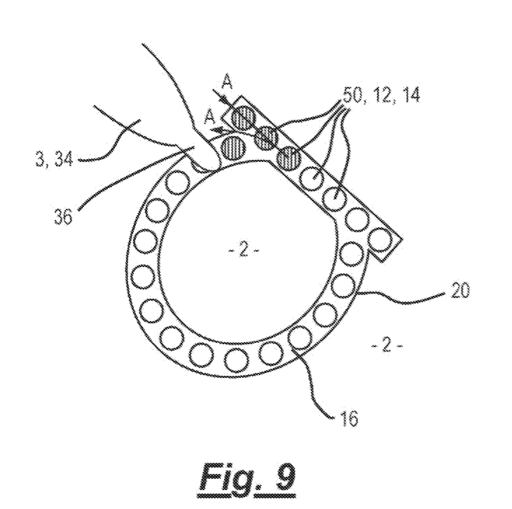

FIG. 9 shows the aid 10 in use. In one example, the light emitters 50 change when the tool tip 36 passes over them within the detectable range of or in contact with the sensor 16. For example, initially the light emitters 50 could be off, and could illuminate when the tool tip 36 moves correctly. In another example, only the next light emitter 50 is illuminated to guide the movement of the pen 3. In another example, the emitters 50 change colour when the pen moves correctly, eg form red to green. In FIG. 9, the emitters 50 over which the pen 3 has correctly passed are shaded, following the movement of the pen 3 indicated by the arrows A.

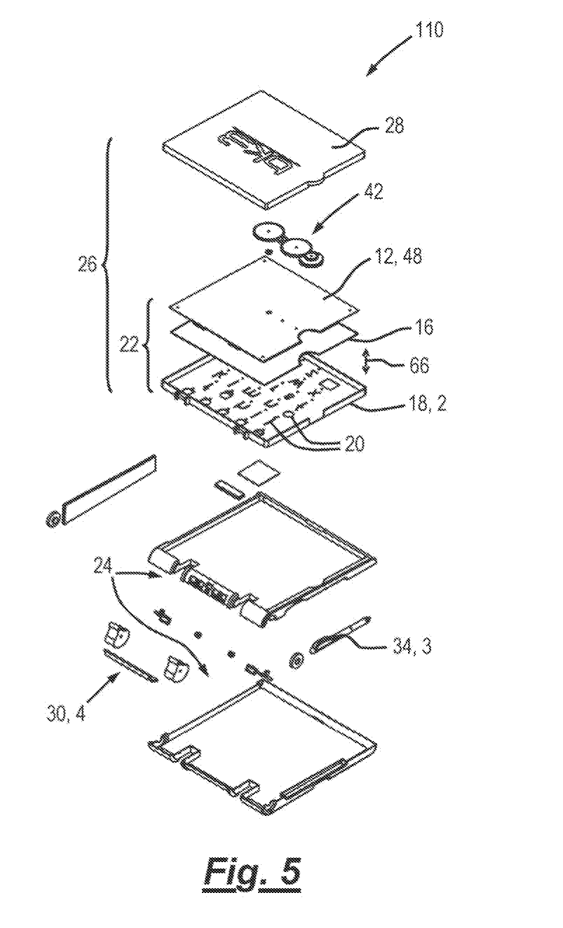

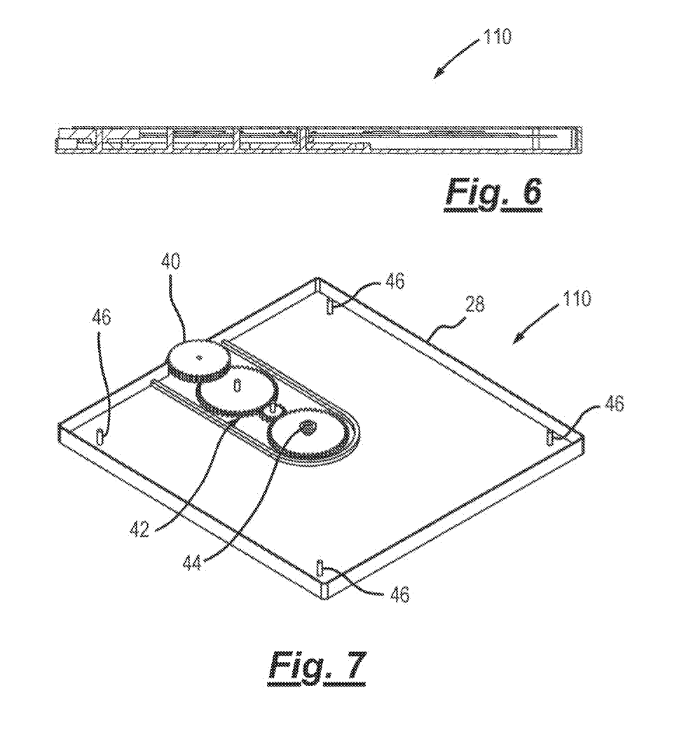

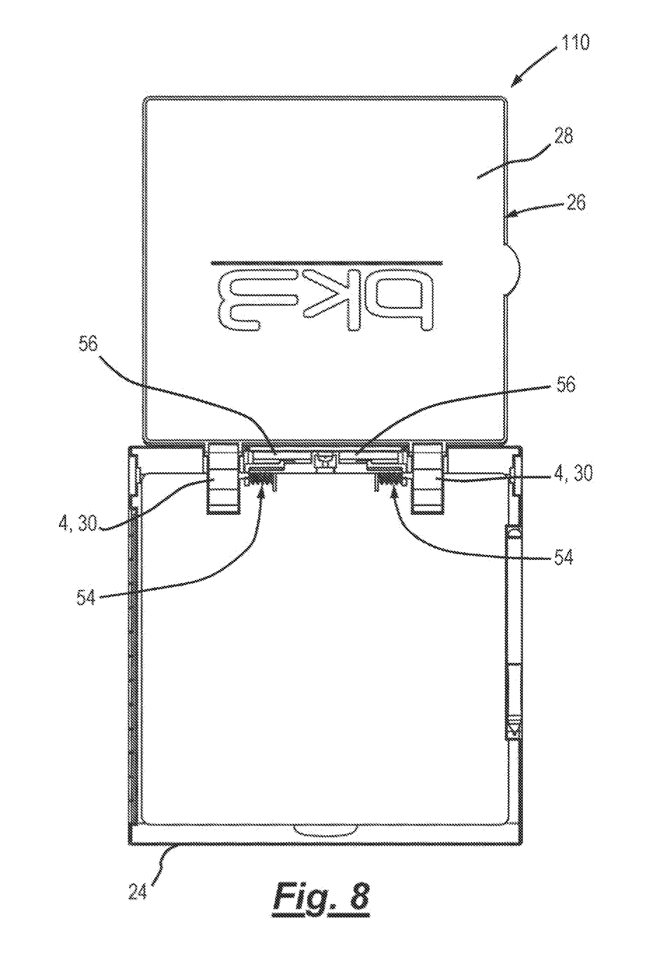

FIGS. 5 to 8 another embodiment of the invention, many features of which are similar to those already described in relation to the embodiment of FIGS. 1 to 4. Therefore, for the sake of brevity, the following embodiment will only be described in so far as it differs from the embodiment already described. Where features are the same or similar, the same reference numerals have been used and the features will not be described again.

FIGS. 5 to 8 show another learning aid 110 including an adjuster 38 for adjusting the spacing 66 between the guide member 18 and the sensor 16. By adjusting the spacing 66, the guide member 13 provides more or less guidance to the pen 3 and thus the degree of difficulty for the user can be varied.

In the example shown, the adjuster 38 includes a thumbwheel 40 which via a gear arrangement 42 rotates a screw 44 which moves the display member 12 and the sensor 16 relative to the guide member 18, The adjuster 38 includes a plurality of guides 46 in the form of pins which extend from the cover member 18 through holes in the display member 12 and the sensor 16 to guide the movement of the display member 12 and the sensor 16.

The learning aid 110 includes a mounting 130 which permits detachment of the lid 26 from the casing 24. The mounting 130 includes a pair of spring loaded pins 54 which engage the hinges 4. The pins 54 are operated by sliding release buttons 56. When the user slides the release buttons 56 against the action of the springs, the pins 54 disengage from the hinges 4 and the lid 26 can be detached from the casing 24. This permits a different lid with a different symbol set to be mounted to the casing. For example, as the child develops, the letters in the symbol set could be made progressively smaller, and/or the symbol set could include words and/or sentences.

Various other modifications could be made without departing from the scope of the invention. The learning aid and the parts thereof could be of any suitable size and shape, and could be formed of any suitable material.

The adjuster could be different. For example, the adjuster could comprise wedges which move to vary the spacing.

Any of the features or steps of any of the embodiments shown or described could be combined in any suitable way, within the scope of the overall disclosure of this document.

There is thus provided a learning aid which economically provides a guided learning experience for a child. The aid is robust and requires minimal adult supervision. The aid provides variety yet encourages completion of the task. The aid is compact and can be easily stored. The interface is stored internally in the storage condition for protection.

1. A learning aid comprising:
a display member for displaying a predefined symbol set;
a sensor for detecting interaction with said display member by a user in use; and
a guide member which in a use condition overlays the display member to guide the interaction by the user.

2. The aid according to claim 1, in which the guide member defines at least one aperture, and the aperture or apertures correspond to the symbol set.

3. The aid according to claim 1, in which, in the use condition, the sensor is located between the display member and the guide member.

4. The aid according to claim 1, in which the display member, the sensor and the guide member comprise an interface.

5. The aid according to claim 4, in which the display member, the sensor and the guide member are substantially planar and the interface is substantially planar.

6. The aid according to claim 1, in which the learning aid includes a casing and a lid, and the lid comprises the display member, the sensor, the guide member and a cover member.

7. The aid according to claim 6, in which the learning aid includes a mounting for mounting the lid to the casing, wherein the mounting is one of (i) a detachable mounting, (ii) a rotating mounting and (iii) a double hinge mounting.

8-9. (canceled)

10. The aid according to claim 9, in which the mounting permits rotation of the lid through an angle of at least 340° around the casing.

11. (canceled)

12. The aid according to claim 6, in which_the lid is movable between a storage condition in which the cover member is outermost on one side of the casing and the use condition in which the guide member is outermost on the other side of the casing.

13. The aid according to claim 12, in which the casing defines lid recesses, in which the lid is receivable in the storage and the use conditions.

14. The aid according to claim 1, in which the learning aid includes a detectable tool, which may be a pen or stylus, which is detectable by the sensor when within a detection range of or in contact with the sensor.

15. The aid according to claim 14, in which the tool includes a tip, which in use is locatable within the aperture(s).

16. The aid according to claim 1, in which the aid includes one or more alternative lids, each of which may include a different symbol set.

17. The aid according to claim 2, which_the or each aperture is in the form of a groove.

18. The aid according to claim 1, in which the aid includes an adjuster for adjusting the spacing between the guide member and the sensor.

19. The aid according to claim 1, in which the display member includes a plurality of light emitters, wherein, in use, at least some of the light emitters are illuminated to display at least part of the symbol set.

20. The aid according to claim 1, in which the display comprises a printed circuit board.

21. The aid according to claim 1, in which the sensor comprises a pad capable of registering interaction.

22 The aid according to claim 21, in which_the guide member comprises a perforated plate, which is adapted to be arranged in use over the pad to alter parameters of interaction registered on the pad.

23. The aid according to claim 1, in which the learning aid includes activation controls.

24-27. (canceled)
